(19) United States
(12) Patent Application Publication
(10) Pub. No.: US 2016/0150009 A1
(43) Pub. Date: May 26, 2016

(54) ACTIONABLE SOUVENIR FROM REAL-TIME SHARING

(71) Applicant: Microsoft Technology Licensing, LLC, Redmond, WA (US)

(72) Inventors: Heather LeRoy, Los Gatos, CA (US); Sarah Joers, Seattle, WA (US); Peter Bergler, Duvall, WA (US); Gregory Howard, Kirkland, WA (US); Vu Nguyen, Bellevue, WA (US); Mansoor Jafry, Kirkland, WA (US); Kerry Woolsey, Duvall, WA (US); Jeremiah Whitaker, Kirkland, WA (US); Karen Wong-Duncan, Bellevue, WA (US); Sanjay Kidambi, Sammamish, WA (US); Peter Hammerquist, Shoreline, WA (US)

(21) Appl. No.: 14/553,726

(22) Filed: Nov. 25, 2014

(51) Int. Cl. H04L 29/08; H04L 12/58

(52) U.S. Cl. CPC H04L 67/1095; H04L 51/08; H04L 51/046

(57) ABSTRACT

A souvenir is provided to enable participants in a real-time sharing session to retain access to the shared content and experiences when the real-time sharing is completed in a fully actionable manner in which all of the functionality and interactivity of the content and experiences are maintained as when they were originally shared. Each of the sharing participants can get a souvenir that can be used to initiate access to the shared content such as a photo or replay an experience such as a telling of a bedtime story. In cases where user generated content (UGC) such as mark-ups, annotations, commentary, content links, highlights, animations, graphics, drawings, directions, points-of-interest, etc., were part of the real-time sharing session—for example, an annotated webpage, a marked-up map, voice commentary over a video recording of a live event, etc.—such UGC can be maintained as part of the post-sharing actionable souvenir experience too.

### BACKGROUND

Users often use computing devices to share various types of content, applications, and experiences with others. Once a sharing session is concluded, a device user typically will initiate a separate asynchronous communication session when he or she wants to revisit the shared content. For example, if content hosted on a website is shared during a sharing session, a user wanting to see the content again after the session is over will launch a browser application, bring up the website, and then navigate to the specific content of interest.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A souvenir is provided to enable participants in a real-time sharing session to retain access to the shared content and experiences when the real-time sharing is completed in a fully actionable manner in which all of the functionality and interactivity of the content and experiences are maintained as when they were originally shared. Provisioning of the actionable souvenir is automated so that each of the sharing participants gets a souvenir that hehe/she can each independently use later (even in cross-platform device contexts)) to, for example, initiate access to the shared content, such as an album of pictures or music; replay an experience like a parent's reading of a bedtime story to a child; revisit items shown on particular pages of an online catalog; take the next turn in a turn-by-turn online game; check on airline flight status after travel planes are shared; or relook at a park map and trail directions shared by a friend once a nature walk begins. In cases where user-generated content (UGC) such as mark-ups, annotations, commentary, audio/video (e.g., voice/video narration or conversations, music, etc.) content links, highlights, animations, graphics, drawings, directions, points-of-interest, etc., was part of the real-time sharing session—for example, an annotated webpage, a marked-up map, voice commentary over a video recording of a live event, etc.—such UGC can be maintained as part of the post-sharing actionable souvenir experience in some scenarios, or participants can choose to access the underlying shared content with just some of the UGC from the original real-time sharing, or none of it in other scenarios. For example, a participant may wish to reuse content from an earlier real-time sharing session in a later session and have an ability to add UGC from scratch or otherwise modify the underlying content. In some implementations, when a participant later accesses and modifies content, those modifications can be dynamically provided to the original real-time sharing participants as updates. In other implementations, shared content and experiences may be statically maintained so that such subsequent modifications are not provided as updates to the participants to the original real-time sharing.

In various illustrative examples, a unified messaging system (which may comprise a remote service that interoperates with local clients) is arranged to expose an application programming interface (API) that enables sharing applications instantiated on a device such as a personal computer (PC), tablet computer, smartphone, multimedia console, or wearable computing device to provide an actionable souvenir from a real-time sharing experience that each sharing participant may use post-sharing to revisit content and experiences in a fully actionable manner. Real-time sharing session data collected at the API may be combined with contextual data pertaining to the user and the user's preferences and behaviors to automate post-real-time sharing tasks performed by the unified messaging system when supporting an actionable souvenir experience. The unified messaging system may also expose its own native real-time sharing feature set in some implementations.

The unified messaging system may utilize heuristics that apply contextual data and/or sharing history to determine when and how to surface an actionable souvenir and then tailor the post-sharing actionable souvenir experience to the user in an intelligent manner that enables the experience to be a faithful and comprehensive re-creation of the original real-time sharing. The sharing party may also be enabled to exercise fine-grain control over a post-sharing actionable souvenir experience by implementing restrictions on access to certain content and experience post-sharing, controlling how content and experiences are presented during the post-sharing, placing time limits on the post-sharing access, and/or enabling or restricting downloading or replication of shared content to a local device. Cross-platform support may also be enabled in some implementations using a web service that interactsinteracts with a local client soso that the features and experiences of the actionable souvenir can be implemented and rendered to participants using different types of devices having, for example, different operating systems (e.g., Windows®, IOS®, Android™, etc.), feature sets, and/or capabilities, etc.

Advantageously, the present actionable souvenir provides a convenient way for sharing participants to go back and revisit shared content and experiences without having to recreate them from scratch. Depending on the context of the original real-time sharing, the actionable souvenir can take a user right back to where the real-time sharing session left off. For example, the actionable souvenir can include a deep link to an online clothing retailer website to bring up the specific catalog page showing an item having a particular color or size that was discussed among the participants during the real-time sharing. In other contexts, an actionable souvenir experience can support replay of sharing sessions in whole or part such as a storytelling session, or a lecture or presentation where a virtual whiteboard or other collaborative tools are utilized, where it may be useful to again experience the sharing as it progresses. In non-experience replay contexts, the actionable souvenir can facilitate convenient post-sharing access to previously shared content such as maps, songs, and photos, etc., in a contextually relevant manner. Actionable souvenirs let real-time sharing participants easily monitor when something has changed or when an event of interest occurs. For example, after travels plans are shared during a real-time session, an actionable souvenir can be used to check on an arrival status for a flight. The actionable souvenir can also provide a notification of a new high score in a game that the participants had been playing during a prior real-time sharing session. In addition, the unified communications system can manage the resources employed to support the actionable souvenir experience so that, for example, data storage for the post-sharing content is efficiently utilized and processing resources are efficiently allocated between local and remote components of the unified communications systems.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative environment in which devices having communications capabilities interact over a network;

FIG. 2 shows illustrative sharing among multiple device users;

FIG. 3 shows an illustrative taxonomy of shareable content;

FIG. 4 shows an illustrative layered architecture that includes an application layer, operating system (OS) layer, and hardware layer;

FIG. 5 shows an application programming interface (API) exposed by a unified communications client to sharing applications;

FIG. 6 shows an illustrative arrangement in which a unified communications service and clients operating on local and remote devices provide an extensible sharing platform;

FIG. 7 shows illustrative inputs to a unified communications system and an illustrative taxonomy of features and functions that may be supported by the system;

FIGS. 8 and 9 show screen captures of illustrative user interfaces (UIs) displayed on devices during real-time sharing sessions;

FIG. 10 illustratively shows a unified communications service surfacing actionable souvenirs that are associated with a real-time sharing session to each participant;

FIG. 11 illustratively shows a unified communications service supporting an actionable souvenir experience with each of the participants to the real-time sharing session;

FIGS. 12 and 13 show screen captures of illustrative UIs respectively exposed by devices that support actionable souvenirs associated with a real-time sharing session;

FIGS. 14 and 15 show initiation of actionable souvenir experiences;

FIG. 16 shows illustrative interactions between a unified communications client on a local device, a unified communications service, and client components on a remote device;

FIGS. 17, 18, and 19 show illustrative methods that may be performed when implementing the present actionable souvenir from real-time sharing;

FIG. 20 is a simplified block diagram of an illustrative computer system such as a personal computer (PC) that may be used in part to implement the present actionable souvenir from real-time sharing;

FIG. 21 shows a block diagram of an illustrative system that may be used in part to implement the present actionable souvenir from real-time sharing;

FIG. 22 is a block diagram of an illustrative mobile device; and

FIG. 23 is a block diagram of an illustrative multimedia console.

Like reference numerals indicate like elements in the drawings. Elements are not drawn to scale unless otherwise indicated. It is emphasized that the particular UIs displayed in the drawings can vary from what is shown according to the needs of a particular implementation. While UIs are shown in portrait mode in the drawings, the present arrangement may also be implemented using a landscape mode.

### DETAILED DESCRIPTION

A typical motivation for sharing content and experiences with others is to facilitate completion of a shared task. A local user at a desktop computing device may share her screen of a map, for example, with a remote user using a tablet device to make plans for a meet up later in the day. Once the screen sharing is done, however, it often can take some effort by the parties to get access to the shared content or experience as may be needed to complete the task. In the meet up example, the remote user may want to see the map again later as she makes her way to the meet up location.

Usually, the remote user would need to initiate a new asynchronous communication to obtain the map that was previously provided as a screen share. Such effort may be time consuming since the remote user needs to navigate to a map website, ask her friend to send her a link, or start a new session with a map application on her tablet device. And, oftentimes some of the richness and functionality of the original sharing is lost during the later asynchronous communication. For example, during the original real-time sharing the local user may have used available tools to annotate and mark-up the map with content that is specific to the meet up such as turn-by-turn directions, points of interest, and other context-specific information.

The present actionable souvenir provides an automated way for real-time sharing participants to retain access to content or replay the original real-time sharing experience in a rich, active, and fully functional manner after the sharing is done. In the map scenario, the souvenir can include a fully functional map that supports all of the features and interactivity of the original map shared from the local user's desktop. Typically, the actionable souvenir can be accessed and used by either of the sharing participants any time after the original sharing is done (i.e., “post-sharing”) and can expose the original annotations and mark-ups while also supporting the current usage context, for example, by providing dynamic updates to the user's location as she makes her way to the meet-up location. Thus, during a real-time sharing session, a parent can walk a teenage child through directions turn-by-turn for a drive to the dentist's office. During the subsequent actionable souvenir experience, the teen can re-experience a progression of the same turn-by-turn directions as the actual trip unfolds.

The actionable souvenir can also be utilized in a wide variety of other scenarios. For example, when a browser is shared, an actionable souvenir is provided to each of the sharing participants that enables each of them to retain access to the website that was visited including any UGC in the form of edits/revisions, mark-ups, annotations, comments, drawings, etc. When a demonstration of an application is shared, the actionable souvenir enables each sharing participant to have a local instance of the application post-sharing.

If a group of users use their respective device to share a live event, the actionable souvenir provided to each member can include a recording of the event, including any comments and discussion, etc., by members of the group that can be re-watched later. When a game is shared, the actionable souvenir can include a download of the game in some cases and may also include virtual trophies or other awards and recognitions for game participants. Souvenirs can also include mementos of the game such as screen captures of decisive moves, actions, or other gameplay, photos of the winners and/or other participants, etc. When the sharing includes watching gameplay, the actionable souvenir can include a recording of the game's outcome that a sharing participant can watch later, in the event she had to leave the sharing session before the game was over. It is emphasized that these use scenarios are illustrative and are not intended to be interpreted as a limitation on the generality of the present actionable souvenirs.

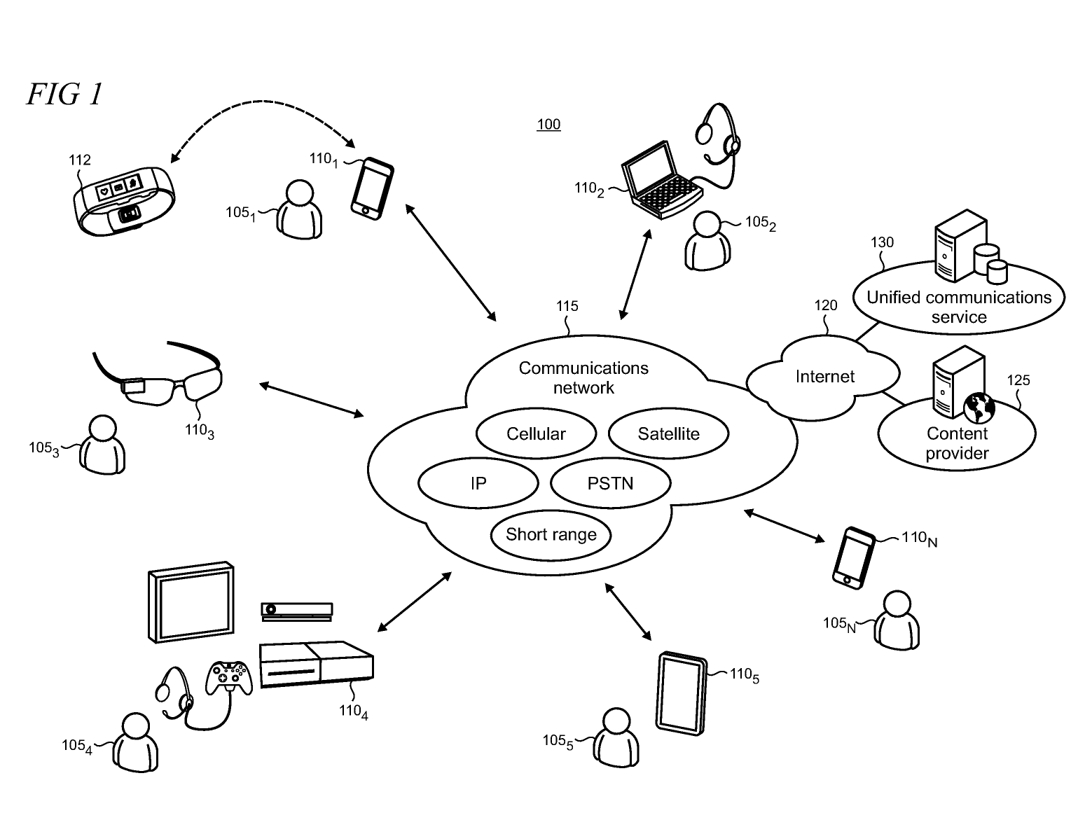

Turning now to the drawings, FIG. 1 shows an illustrative communications environment 100 in which various users 105 employ respective devices 110 that can interact over a communications network 115. The devices 110 provide various capabilities, such as voice and video calling and messaging, and typically support data-consuming applications such as Internet browsing and multimedia (e.g., music, video, etc.) consumption in addition to various other features. The devices 110 may include, for example, user equipment, mobile phones, cell phones, feature phones, tablet computers, and smartphones which users often employ to make and receive voice and/or multimedia (i.e., video) calls, engage in messaging (e.g., texting), use applications and access services that employ data, browse the World Wide Web, and the like. However, alternative types of electronic devices are also envisioned to be usable within the communications environment 100 so long as they are configured with communication capabilities and can connect to the communications network 115. Such alternative devices variously include handheld computing devices, PDAs (personal digital assistants), portable media players, phablet devices (i.e., combination smartphone/tablet devices), wearable computers, navigation devices such as GPS (Global Positioning System) systems, laptop PCs (personal computers), desktop computers, multimedia consoles, gaming systems, networked and/or remotely controlled cameras (e.g., room and home surveillance cameras, body-worn cameras, webcams, external cameras used with PCs, tablets, and other computing devices, remote cameras in vehicles, etc.), or the like. In the discussion that follows, the use of the term “device” is intended to cover all devices that are configured with communication capabilities and are capable of connectivity to the communications network 115.

The various devices 110 in the environment 100 can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, natural language interfaces, and voice commands, while others may enable a more limited UI. Some devices may support video consumption and Internet browsing, while other devices may support more limited media handling and network interface features.

Accessory devices 112, such as wristbands and other wearable devices may also be present in the environment 100. Such accessory device 112 typically is adapted to interoperate with a device 110 using a short range communication protocol like Bluetooth® to support functions such as monitoring of the wearer's physiology (e.g., heart rate, steps taken, calories burned, etc.) and environmental conditions (temperature, humidity, ultra-violet (UV) levels, etc.), and surfacing notifications from the coupled device 110.

As shown, the devices 110 can access the communications network 115 in order to implement various user experiences. The communications network can include any of a variety of network types and network infrastructure in various combinations or sub-combinations including cellular networks, satellite networks, IP (Internet Protocol) networks such as Wi-Fi and Ethernet networks, a public switched telephone network (PSTN), and/or short range networks such as Bluetooth networks. The network infrastructure can be supported, for example, by mobile operators, enterprises, Internet service providers (ISPs), telephone service providers, data service providers, and the like. The communications network 115 typically includes interfaces that support a connection to the Internet 120 so that the mobile devices 110 can access content provided by one or more content providers 125 and access a unified communications service 130 in some cases. The devices 110 and communications network 115 may be configured to enable device-to-device communication using peer-to-peer and/or server-based protocols. Support for device-to-device communications may be provided, at least in part, using various applications that run on a device 110.

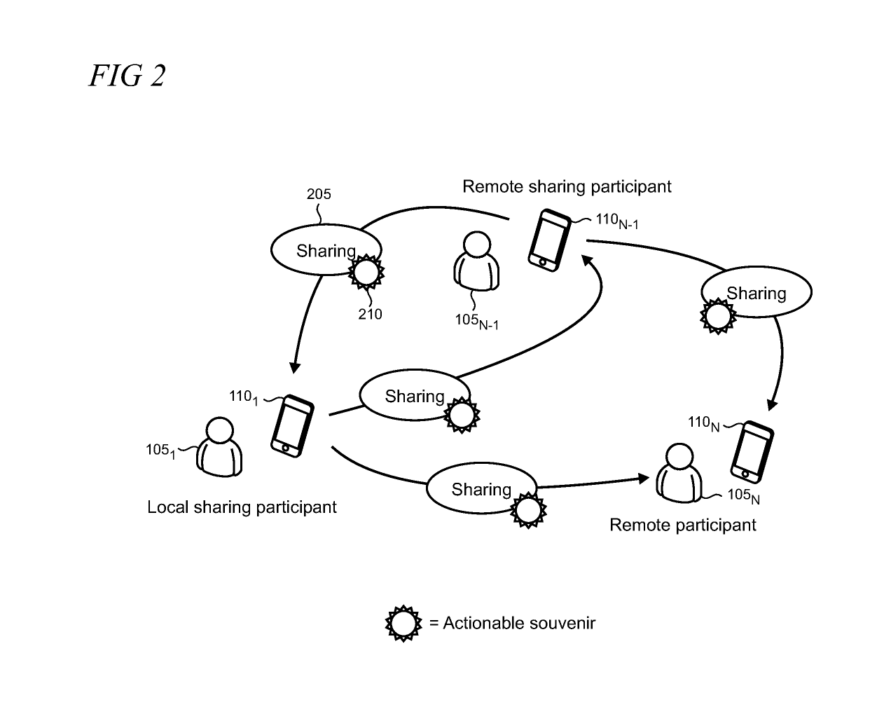

The communications can be utilized to support various real-time sharing experiences and the present actionable souvenir. As shown in FIG. 2, real-time sharing sessions (representatively indicated by reference numeral 205) with actionable souvenirs (representatively indicated by reference numeral 210) can be implemented between a local sharing participant 105₁ and a single remote participant 105_{N} or between the local sharing participant and multiple remote participants in some scenarios. In some cases, one or more of the remote participant can also implement sharing back with the local participant and/or with another participant. In some implementations, controls, tools, and other features can be provided and accessed by one or both participant to edit, modify, annotate, mark up, or otherwise the manipulate the shared content. Real-time sharing and actionable souvenirs may also be implemented using more than one network connection or network type. For example, audio associated with a phone call and sharing session may be carried in part over a PSTN or mobile operator network while shared content such as pictures, video, etc., can be carried over a Wi-Fi or other network.

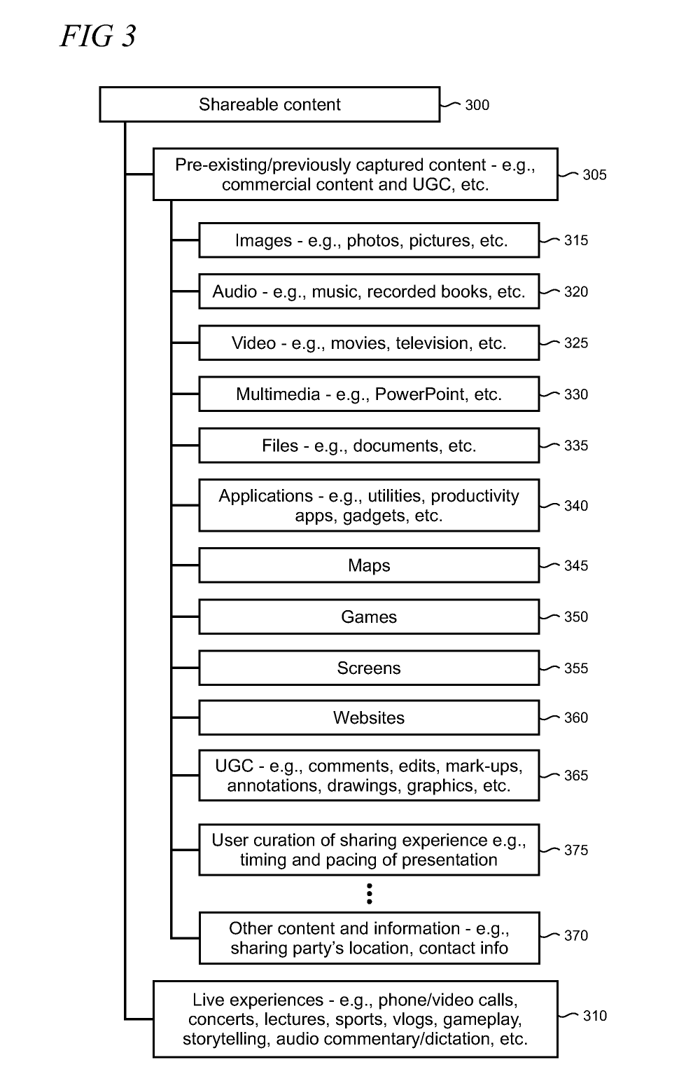

Various types of content can be shared using real-time sharing and retained in an actionable souvenir. FIG. 3 shows an illustrative taxonomy of shareable content 300. It is noted that the shareable content can be stored locally on a device, or be stored remotely from the device but still be accessible to the device. For example, the shareable content can be stored in a cloud store, be available on a network such as a local area network, be accessed using a connection to another device, and the like.

As shown in FIG. 3, the shareable content 300 can include both pre-existing/previously captured content 305 (e.g., commercially available content and/or UGC, etc.), as well as content 310 associated with live experiences and events (e.g., phone/video calls, concerts, lectures, sporting events, gameplay, audio commentary/dictation, video logs (vlogs), storytelling, etc.). The shareable content shown in FIG. 3 is illustrative and not intended to be exhaustive. The types of content supported for real-time sharing with actionable souvenirs can vary according the needs of a particular implementation. In the discussion that follows, the term “content” can be understood to refer to either or both shared content and shared experiences unless otherwise indicated.

Illustrative examples of pre-existing shareable content include images 315, audio 320, video 325, multimedia 330, files 335, applications 340, maps 345, games 350, screens 355, websites 360, UGC 365 (which may be added to other content in the form of revisions/edits, mark-ups, annotations, etc.), and other shareable content 370 such as the sharing party's location and/or contact information.

The way content is curated for presentation by the sharing party, as indicated by reference numeral 375 in FIG. 3, is another illustrative example of sharable content. For example, sharing parties can control the pacing and timing of content presentation to create a sense of drama, convey points in particular ways, or simply to make themselves look good.

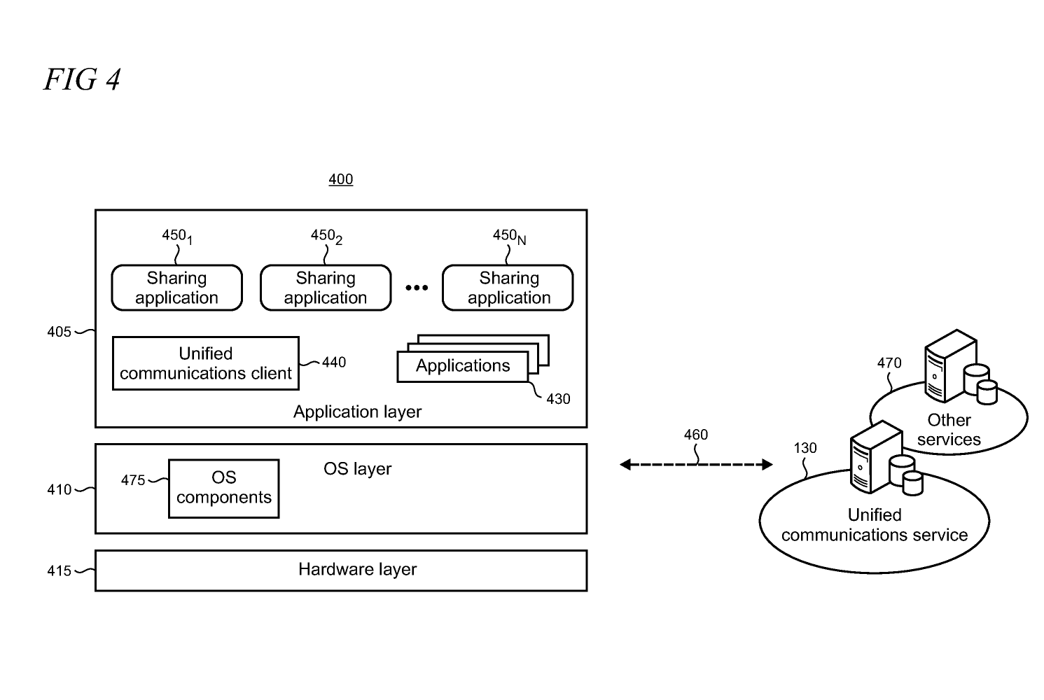

The real-time sharing and actionable souvenir experiences may be implemented using components that are instantiated on a given device 110. In addition, as discussed below, actionable souvenirs can also be implemented, in whole or part, using a web service supported by a remote service provider. FIG. 4 shows an illustrative layered architecture 400 that supports various applications and other components. The architecture 400 is typically implemented in software, although combinations of software, firmware, and/or hardware may also be utilized in some cases. The architecture 400 is arranged in layers and includes an application layer 405, an OS (operating system) layer 410, and a hardware layer 415. The hardware layer 415 provides an abstraction of the various hardware used by the device 110 (e.g., input and output devices, networking and radio hardware, etc.) to the layers above it.

The application layer 405 in this illustrative example supports applications 430 (e.g., web browser, music player, email application, etc.), as well as a unified communications client 440. The client 440 typically is configured to interact with the service 130 to implement a unified communications system. One commercial example of a unified communications system that may be adapted to support various aspects of the present actionable souvenir is Skype™ by Microsoft Corporation. Various applications 450 that support content and experience sharing are also included in the application layer 405 in this illustrative example.

The applications 430 and 450 are often implemented using locally executing code. However in some cases, these applications may rely on services and/or remote code execution provided by remote servers or other computing platforms such as those supported by other cloud-based resources/services 470 as indicated by line 460. While the applications 430, 440, and 450 are shown here as components that are instantiated in the application layer 405, it may be appreciated that the functionality provided by a given application may be implemented, in whole or part, using OS components 475 and/or other components that are supported in the hardware layer 415.

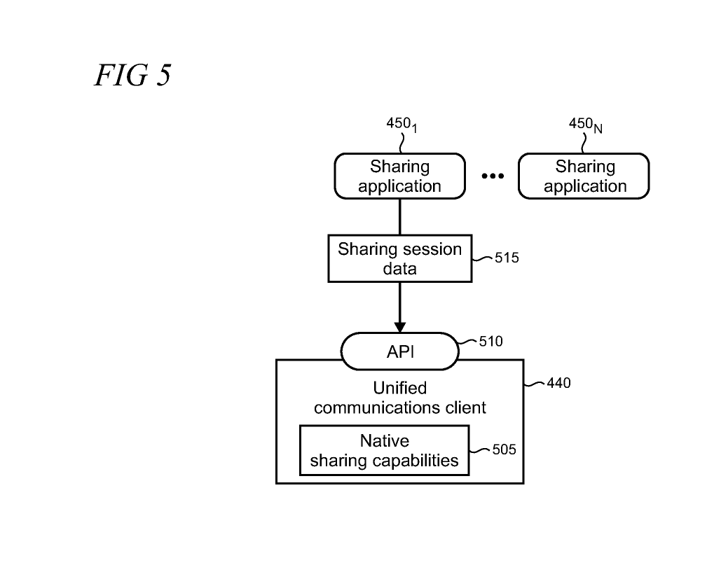

As shown in FIG. 5, the unified communications client 440 can support its own native sharing capabilities 505 in some implementations, and typically in conjunction with the service 130. The native sharing capabilities 505 can support sharing of one or more of the types of content shown in FIG. 3 depending on the needs of a particular implementation. In alternative arrangements, the unified communications client 440 can expose an application programming interface (API) 510 to one or more of the sharing applications 450. The API 510 may enable a sharing application to interoperate with the unified communications service in order to implement actionable souvenir experiences and/or real-time sharing experiences in some implementations. The unified communications client 440 may support the API 510, in some cases, without also supporting its own native sharing capabilities. The API 510 is typically configured to expose various methods and functions to the sharing applications and receive data 515 associated with a given real-time sharing session (and exchange other signals and controls, etc.) as may be needed to implement a particular sharing experience and/or feature.

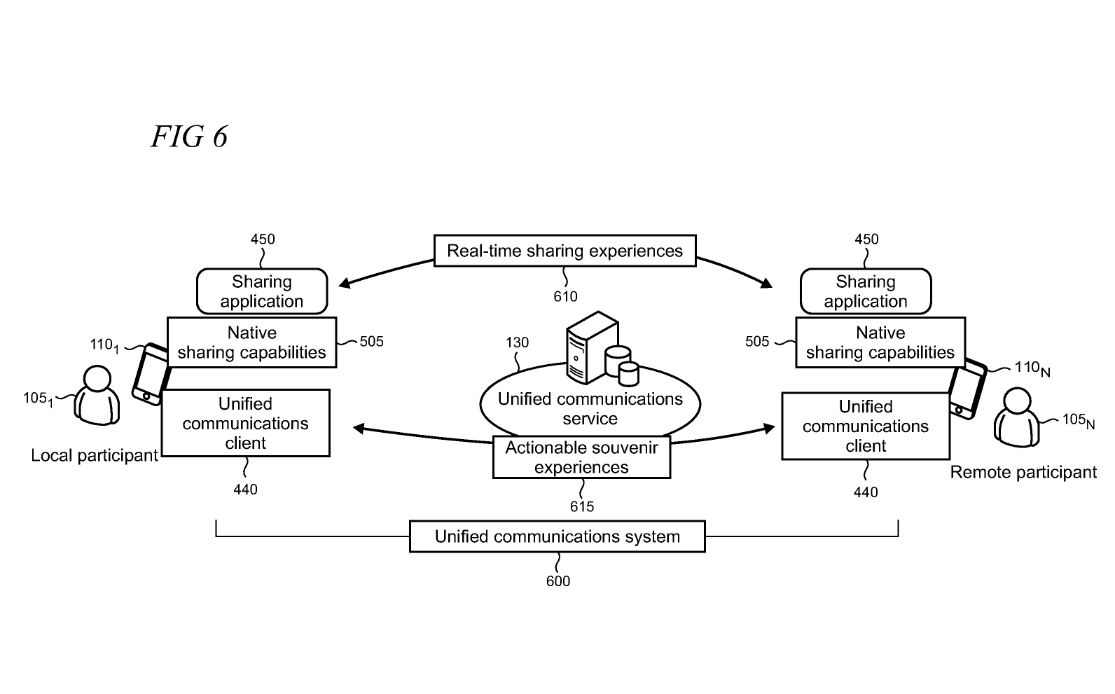

As shown in FIG. 6, by enabling the unified communications system 600 to support real-time sharing experiences 610 from sharing applications 450 (which may supplement or supplant its own native sharing capabilities 505 in some cases), the system 600 functions as an extensible sharing platform on which a variety of real-time sharing 610 and actionable souvenir experiences 615 may be built. In alternative arrangements, the functionalities provided by the unified communications system may be implemented using peer-to-peer networking protocols and services so that devices 110 can participate in real-time sharing and active souvenir experiences without using services supported by a remote provider.

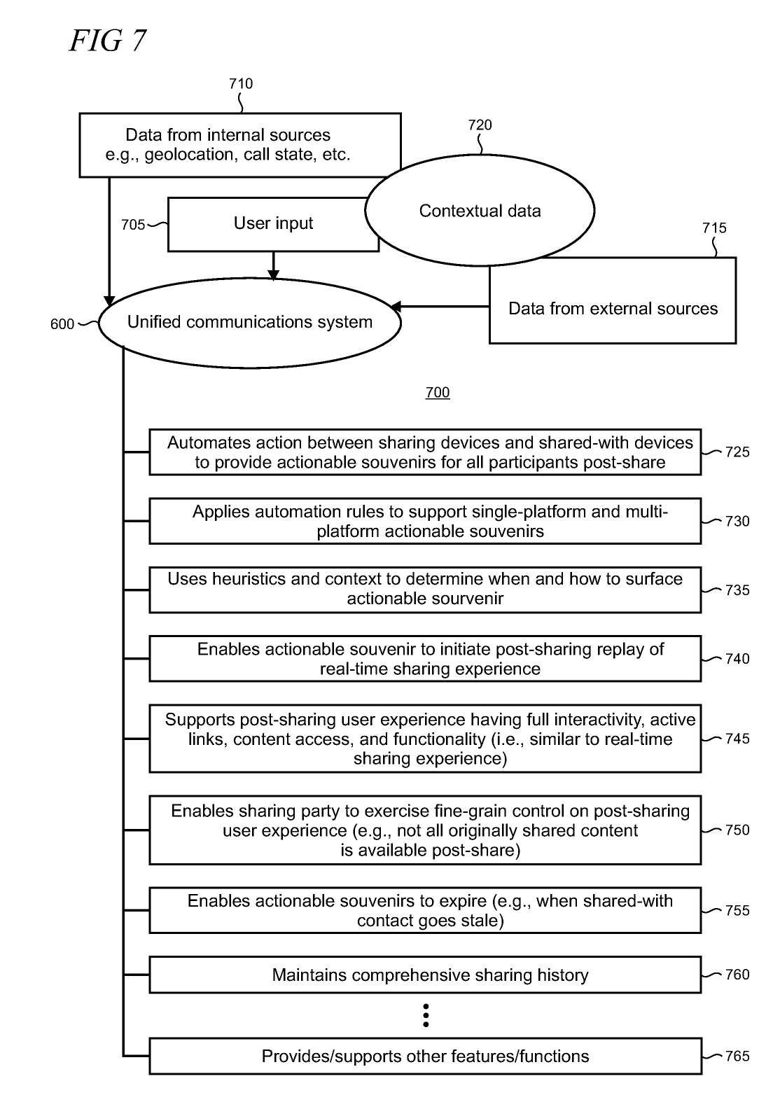

FIG. 7 shows an illustrative taxonomy of functions 700 that may typically be supported by the unified communications system 600. Inputs to the unified communications system 600 typically can include user input 705 (such user input can include input from either or both the local and remote parties to a given sharing session in some cases), data from internal sources 710, and data from external sources 715. For example, data from internal sources 710 could include the current geolocation of the device 110 that is reported by a GPS (Global Positioning System) component on the device, or some other location-aware component. The externally sourced data 715 can include data provided, for example, by external systems, databases, services, and the like. The various inputs can be used alone or in various combinations to enable the unified communications system to utilize contextual data 720 when it operates. Contextual data 720 can include, for example, time/date, the user's location and/or planned route, language, schedule, applications installed on the device and application behaviors and associated data (e.g., high score on a game), the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, communications network type and/or features/functionalities provided therein, mobile data plan restrictions/limitations, data associated with other parties to a communication (e.g., their schedules, preferences, etc.), and the like. Additional illustrative examples of the use of context by the unified communications system 600 are provided below.

As shown, the functions 700 illustratively include: automating actions between sharing devices and shared-with devices to provide an actionable souvenir for each sharing participant to use post-share in order to retain access to shared content and experiences (as indicated by reference numeral 725); applying automation rules to support single-platform sharing and multi-platform (i.e., cross-platform) actionable souvenirs (730) as described in more detail below; using heuristics and contextual data to determine when and how to surface actionable souvenirs to device users (735); enabling the user to employ the actionable souvenir to initiate a post-sharing replay of the real-time sharing experience (740); supporting post-sharing user experiences which have full interactivity, active links, content access and/or other functionality that is similar or identical as in the original real-time sharing experience (745) where the post-sharing user experiences may include the merging of content/experiences from two or more real-time sharing sessions; enabling the sharing party to exercise fine-grain control on the post-sharing user experience (750), for example, by restricting post-share access to certain content and/or experiences that were part of the original real-time sharing; enabling actionable souvenirs to expire (755) in some cases, for example, when a contact with the shared-with party becomes stale with time; maintaining a comprehensive sharing history (760); and providing support for other features and/or functions (765) to meet the needs of a particular implementation of the present actionable souvenir. Various ones of the functions 700 are highlighted in the exemplary real-time sharing and actionable souvenir use cases shown in the drawings and discussed below.

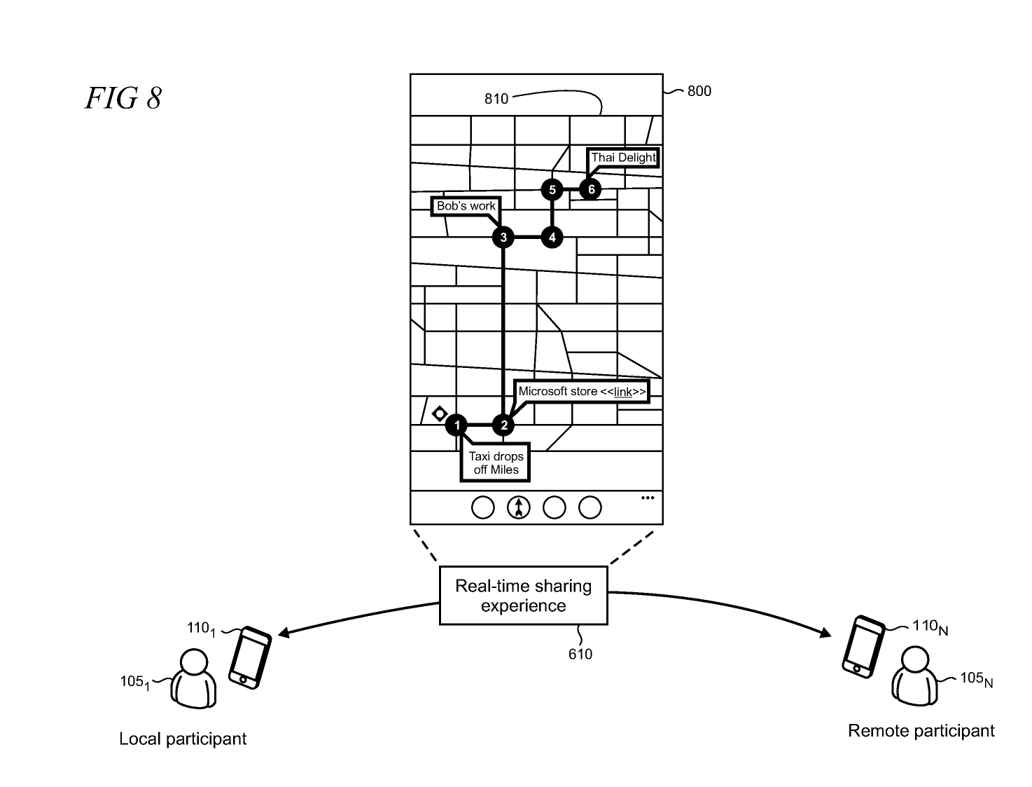

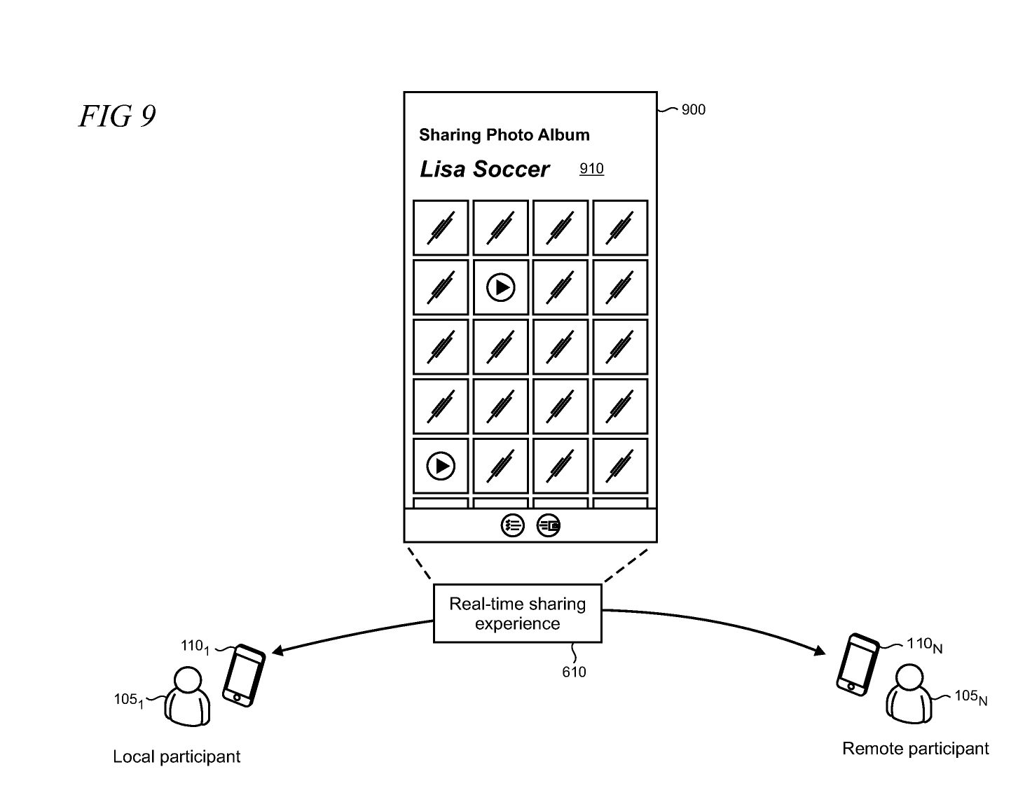

FIGS. 8 and 9 show screen captures of illustrative real-time sharing user interfaces (UIs) displayed on a device (i.e., using a sharing application 450 or native sharing capabilities 505 as shown in FIG. 5) during exemplary real-time sharing experiences. FIG. 8 shows a UI 800 that can be shared between the local and the remote participants to support a shared map experience. In this particular example, the real-time sharing is implemented between a single local and a single remote sharing participant. However, it may be appreciated that this example is illustrative and that multi-party sharing may also be implemented in some scenarios. It is noted that all the UIs shown in the drawings are intended to be illustrative and that the presentation of information, exposed features and controls, and the overall look and feel of the UI can vary from what is shown according to implementation.

As shown in FIG. 8, the UI 800 associated with a real-time sharing experience 610 includes a map 810 which one of the sharing participants 105 has marked up using, for example, tools exposed by an application or the native sharing capabilities, to generate turn-by-turn directions and indicate points-of-interest and other landmarks. A participant has also embedded a live link to other content/experiences on the map. In FIG. 9, the real-time sharing experience 610 includes sharing a photo album 910 named “Lisa Soccer” that has thumbnails of pictures and videos, as shown in the UI 900 (typically, a user can manipulate the thumbnail to expose a full size version of a photo or video of interest). The unified communications system maintains a comprehensive sharing history by monitoring and storing events, content, and related data that are associated with the real-time sharing experiences.

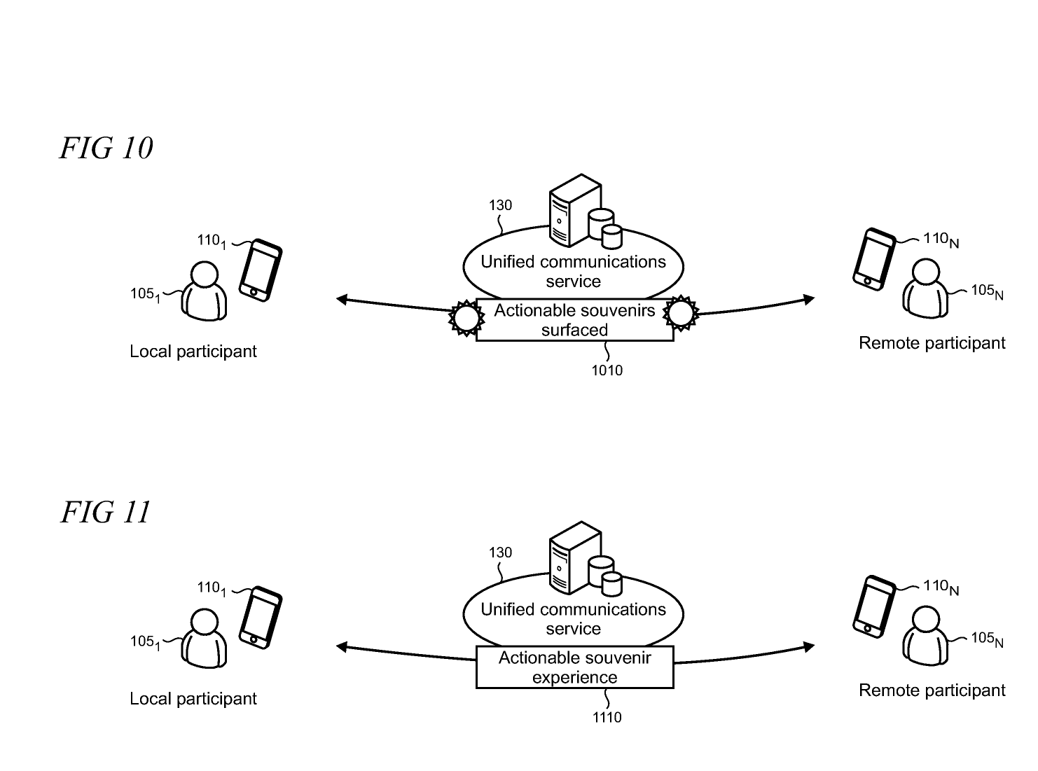

When the real-time sharing experiences are completed, the unified communications service 130 can surface actionable souvenirs for the real-time sharing sessions to each of the sharing participants as indicated by reference numeral 1010 in FIG. 10. In some cases, contextual data and/or rules and heuristics can be utilized to surface the actionable souvenirs, or remind a participant of the availability of a souvenir at contextually relevant times. For example, if the real-time sharing deals with a preparation of a sales presentation to a client, the unified communications client can surface a reminder prior to the occurrence of the client meeting so that the participants can review the presentation. In other cases, the actionable souvenir and/or reminder can be surface in a manner that is consistent with user preferences such as delivery method (e.g., text message, pop-up banner notification, email, in-line in an application, etc.) or time (e.g., Participants can employ the actionable souvenirs to trigger an actionable souvenir experience 1110, as shown in FIG. 11, which may be supported by the unified communications service 130. Actionable souvenirs can also be surfaced when the unified communications system detects an occurrence of a particular event. Such event may include, for example, progress of an application process reaching some threshold percentage of completion, a high score being achieved in a game, or new content becoming available. Actionable souvenirs can also be configured to expire upon a detected occurrence of a particular event. For example, in some cases sharing participants may want to stop post-sharing access to a game once the game has been completed and someone has been declared the winner.

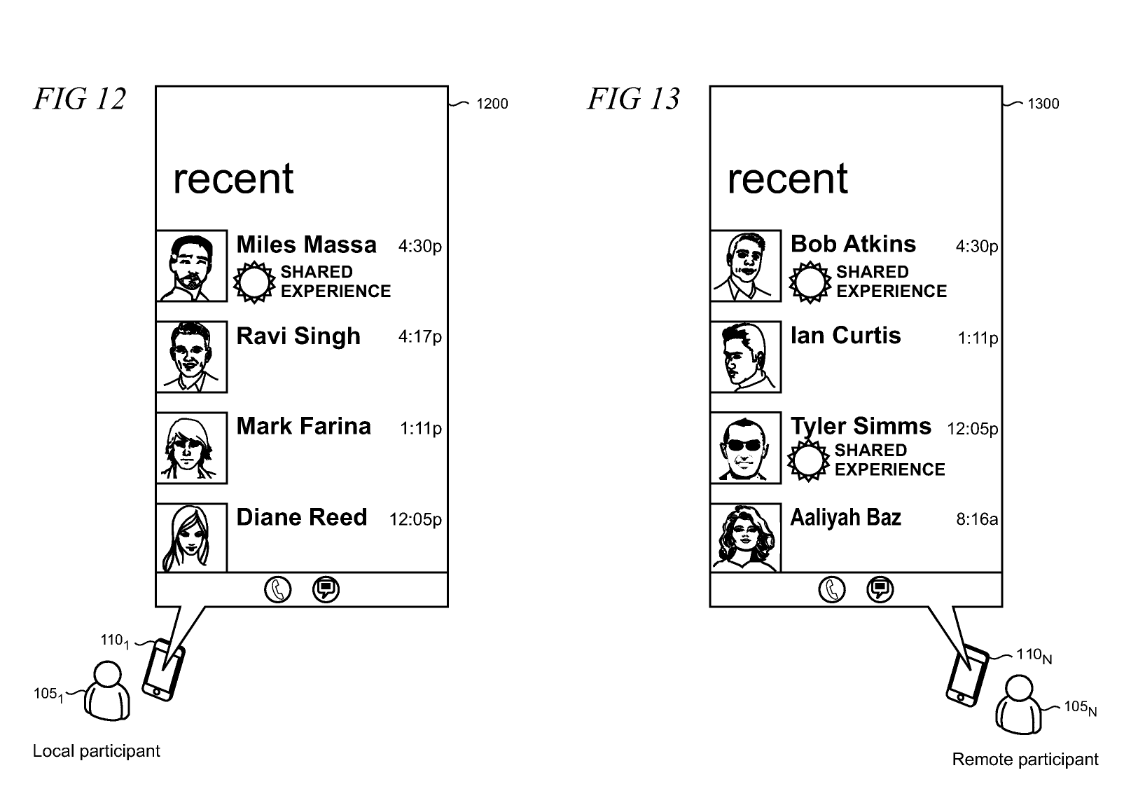

The actionable souvenir experience 1110 enables the participants to retain access to the shared content and experiences when the real-time sharing is completed in a fully actionable manner in which all of the functionality and interactivity of the content and experiences is maintained as when they were originally shared. As shown in FIGS. 12 and 13, home screen UIs 1200 and 1300 may be exposed by the unified communications client on the respective devices 110 of the local and remote participants which include graphic objects or other control devices to indicate that an actionable souvenir is available.

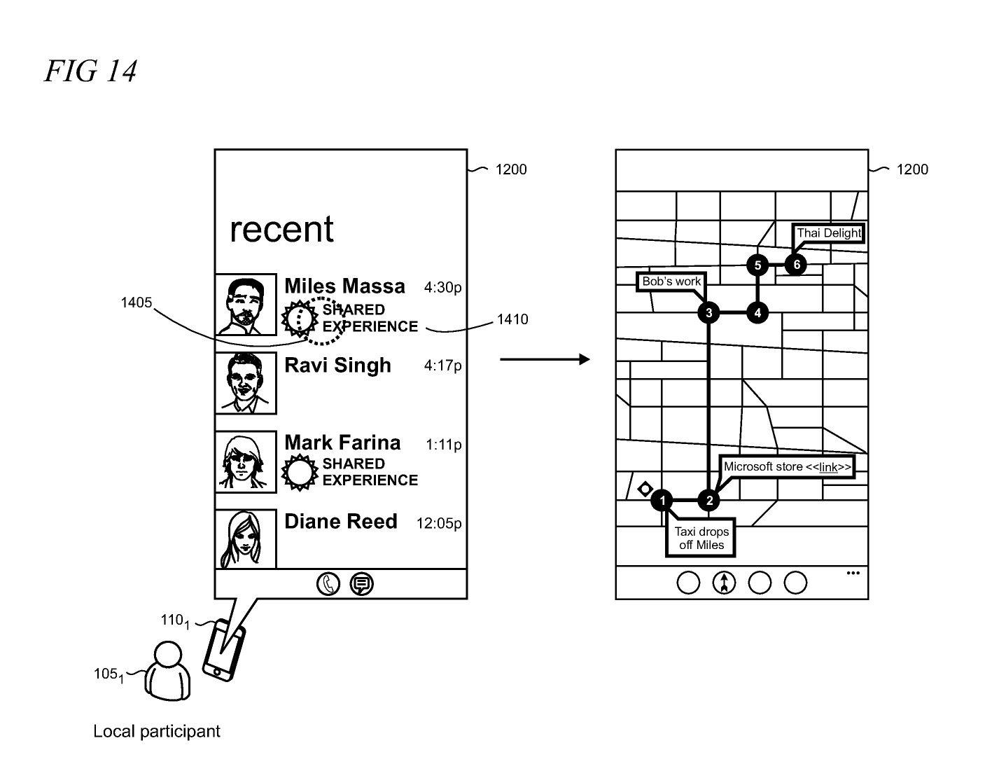

When the user invokes the actionable souvenir, for example using a touch 1405 on the souvenir graphic object 1410 as shown in FIG. 14, the map 810 from the original real-time sharing session (shown in FIG. 8) is surfaced. It is noted that such touch action is illustrative and that other types of user interactions (e.g., voice commands, natural language interface interactions, manipulation of physical and/or virtual controls, etc.) may be utilized depending on the capabilities of specific devices and the context of a given implementation. In some cases, actionable souvenirs can be organized for presentation through the UI using a channel paradigm in which each sharing participant is provided with his/her own channel by the unified communications service. The UI can be configured to enable participants to turn particular channels on and off in some scenarios so that sharing in one or both directions among participants (see, FIG. 2 above and the accompanying text) can be finely controlled to optimize real-time sharing and actionable souvenir experiences.

Content and experiences including the user-generated content such as the directions, points-of-interest, and live links are maintained on the map post-sharing so that all or significant portions of the features and functionality of the original real-time sharing experiences are retained. When the map 810 is surfaced post-sharing it can also be updated by the unified communications system to reflect the current usage context. For example, the map may be updated to show the location of the participants and/or their progress towards the meet up location, provide new directions in case a user deviates from the original planned route, surface relevant notifications such as a change in meet up time or location, and the like.

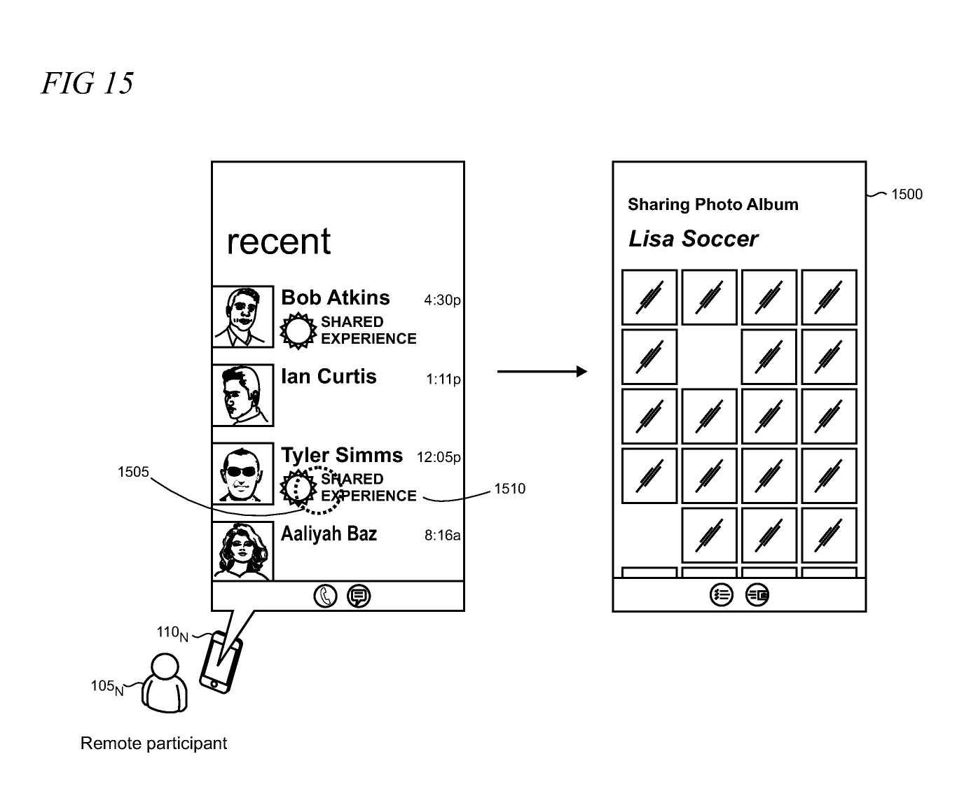

FIG. 15 shows the remote participant employing a touch 1505 on the souvenir graphic object 1510 to surface the photo album 910 from the original real-time sharing (shown in FIG. 9). In this particular illustrative example, the photo album that is accessible post-sharing is modified from that shared during the real-time sharing. More specifically, the sharing participant has used controls exposed by the unified communications system to exercise fine-grain control over the actionable souvenir experience by restricting post-share access to the video content in the album so that thumbnails of the videos are removed from the UI 1500, as shown.

The controls may include a dialogue box or similar device/object surfaced by the UI that enables the sharing participant to suppress souvenirs for shared content. Thus, some content can be shown during a real-time sharing session, but the sharing participant can elect to disable any future access by the other participant to such content. In some implementations, a participant may enable the system to apply rules, which can be context-based in some cases, to automatically limit content included in a real-time sharing and/or actionable souvenir. For example, the unified communications system can look at authentication systems and domains being accessed and the like in order to determine whether sharing is work related or personal, In scenarios in which sharing is determined to be personal, the system can restrict sharing and souvenirs from including professional content to protect against accidental disclosure of confidential business information. Likewise, when sharing is determined to be work-related, the system can place restrictions on sharing and souvenirs from including personal content to enhance and preserve privacy of the sharing participant. For the shared-with participant, automation rules can apply context to determine where to store shared content, for example, as described below.

Another example of fine-grain control may include configuring shared content to be accessible for download by the remote participant for a limited duration time period and/or during a user-specified time interval. In other implementations, the shared content can be arranged to be remotely viewed after the real-time sharing session ends, but only for a limited time period and/or during a user-specified time interval. In some cases, the unified communications system can revoke or disable an actionable souvenir when the shared-with contact goes stale. For example, the available contextual data may indicate that a user is no longer in touch with the contact, or the contact has been removed from the user's address book, or has been removed from the user's social network, and the like.

Other examples of fine-grain control can include the suppression of some content from sharing and souvenir experiences that the sharing participant may have flagged as being personal and/or private or which may be restricted for distribution, for example, by digital rights management (DRM) or similar paradigms. In addition, the unified communications system can be configured to monitor for the potential release of sensitive private information such as passwords, financial information, personally identifying information (PII), and the like during real-time sharing and/or actionable souvenir experiences. In some implementations, default system behaviors can be configured to automatically exclude private information from sharing and/or actionable souvenirs unless such default behaviors are explicitly overridden by a user. For example, if such sensitive information is detected as about to be shared, the system can expose a prompt to inform the sharing participant of the sensitive nature of the information and verify that it is intended to be shared. Similarly, such private information can be automatically excluded from an actionable souvenir experience. Generally, the unified communications system is implemented in a manner that provides sharing participants with information as to what kinds of content is being shared and supports easy ways to manage the sharing that protect privacy and improve security by reducing chances of accidental and unintended sharing.

The photo album associated with the actionable souvenir experience can be automatically stored locally on the device of the remote participant (i.e., the shared-with participant) or using remote storage (e.g., cloud-based storage) associated with the participant using available contextual information. The unified communications system can apply rules and/or heuristics to the contextual data to determine where to store the photo album. For example, the unified communications system examines the context of past communications between the participants, attributes associated with the shared-with participant (e.g., email domain, whether the shared-with participant is identified as a business or personal contact, etc.), the time of day the real-time sharing occurred, and other data to determine that the photo album deals with personal content and not business-related content. Accordingly, the photo album can be stored in the shared-with participant's personal cloud-based storage. If the application of rules and heuristics determines that the photo album includes business-related content, then the photo album can be stored in the shared-with participant's professional cloud-based storage.

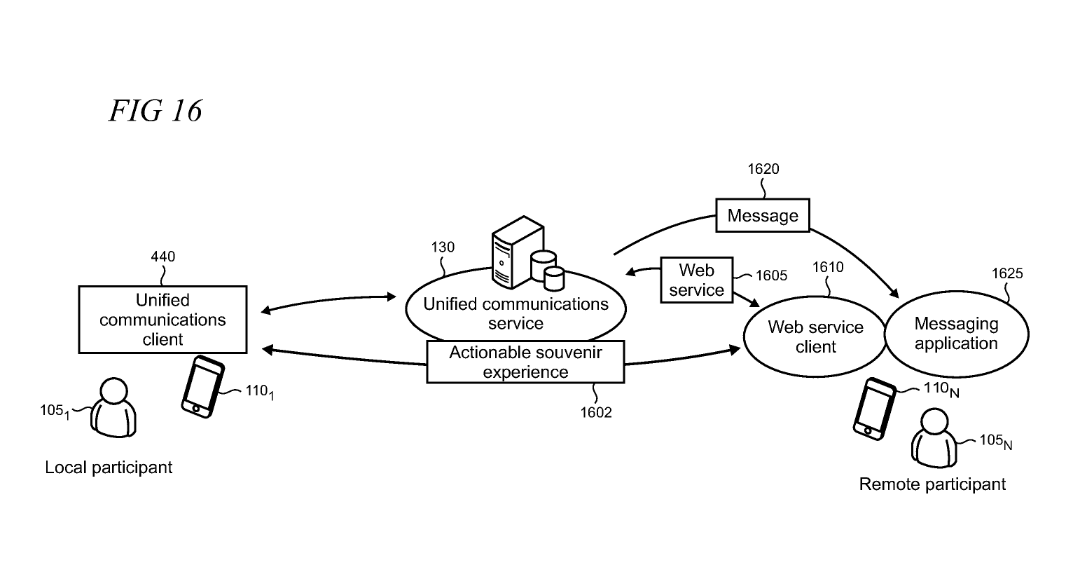

In some actionable souvenirs from real-time sharing scenarios, each of the devices utilized by participants in the sharing (whether single instances of sharing or multi-instance sharing among two or more participants) can have a unified communications client 440 installed and executing to support an actionable souvenir user experience. In other scenarios, one or more of the participants may not have a unified communications client 440 instantiated on their device. In such cases, an actionable souvenir experience may still be implemented with a full set of features and user experiences by leveraging capabilities provided by unified communications service 130 as shown in FIG. 16. For example, the unified communications service 130 (or another remote service provider in some cases) can host a web service 1605 for a web service client 1610 such as a browser or other application on the remote device. An actionable souvenir experience 1602 may then be furnished by the service 130 to the client 1610 for rendering at the remote device.

During a real-time sharing session or at its conclusion, the unified communications service 130 can send a message 1620 to a messaging application 1625 that is available on the remote device. For example, the message 1620 can be a text message that is transported using SMS (Short Message Service) or MMS (Multimedia Messaging Service) that contains a link that the remote party can follow to participate in the actionable souvenir experience.

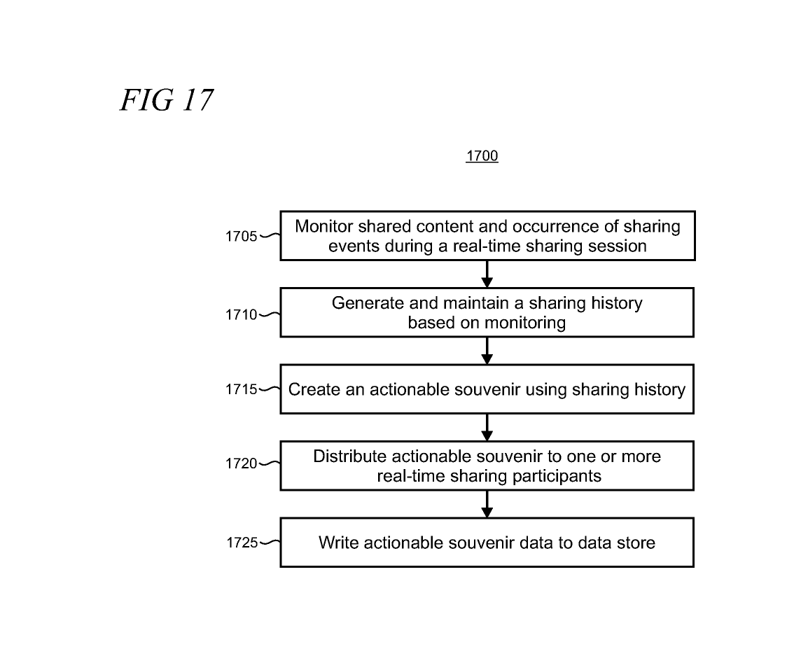

FIG. 17 shows a flowchart of an illustrative method 1700 for implementing aspects of the present actionable souvenir from real-time sharing. Unless specifically stated, the methods or steps shown in the flowcharts below and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1705, the unified communications system can monitor the content that is being shared and the sharing events that occur during a real-time sharing session. In step 1710, the system will generate and maintain a sharing history based on the monitoring. In step 1715, the system can create an actionable souvenir from the real-time sharing session using the sharing history. In step 1720, the actionable souvenir may distribute the actionable souvenir to one or more of the real-time sharing participants. In some implementations, the actionable souvenir is typically distributed to each of the sharing participants over the communications network 115 shown in FIG. 1 and described in the accompanying text. In step 1725, the system can write data associated with the actionable souvenir to a data store. In some cases, the data can be written to a remote store. Alternatively, the unified communications client can write actionable souvenir data to a local data store on the device. Actionable souvenir data can also be stored using a combination of local and remotes data stores.

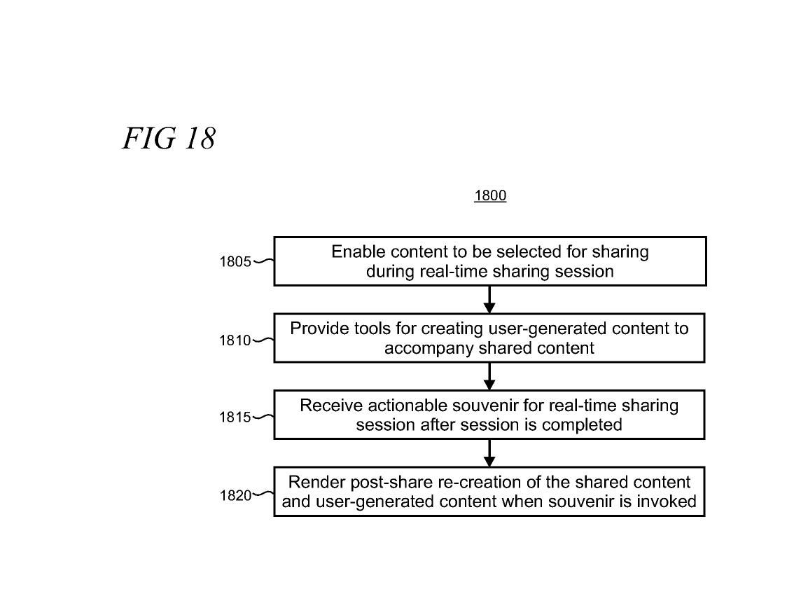

FIG. 18 shows a flowchart of an illustrative method 1800 that may be performed on a device 110. In step 1805, the unified communications client and/or one or more sharing applications may be configured to enable content to be selected for sharing. Sometimes, the shared content is stored locally on the device, while in other situations the shared content can be accessed by the device from a remote location. In step 1810, tools may be provided by the client and/or sharing applications that allow one or more of the sharing participants to create user-generated content that can accompany the shared content. As noted above, such UGC can modify or supplement the shared content and can variously include annotations, comments, mark-ups and the like.

In step 1815, after the real-time sharing session is completed, the device can receive an actionable souvenir from the unified communications system. When the actionable souvenir is invoked, in step 1820, a post-share re-creation of the shared content and UGC is rendered at the device.

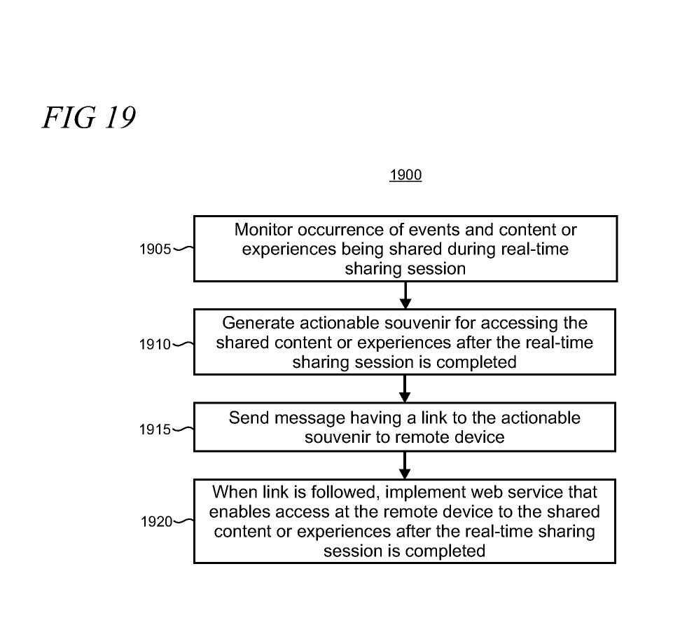

FIG. 19 shows a flowchart of an illustrative method 1900 that can be utilized in cross-platform scenarios or when a remote device does not have a unified communications client installed. In step 1905, the unified communications system can monitor content or experiences that are being shared and the sharing events that occur during a real-time sharing session. In step 1910, an actionable souvenir that enables post-sharing access to the shared content or experiences is created. In step 1915, the unified communications system may send a message (e.g., an SMS or MMS message) to the remote device where the message includes a link to the actionable souvenir. When the user at the remote device follows the link in the message in step 1920, the unified communications service can expose a web service to a client on the remote device which can render the shared content or experiences after the real-time sharing session is completed.

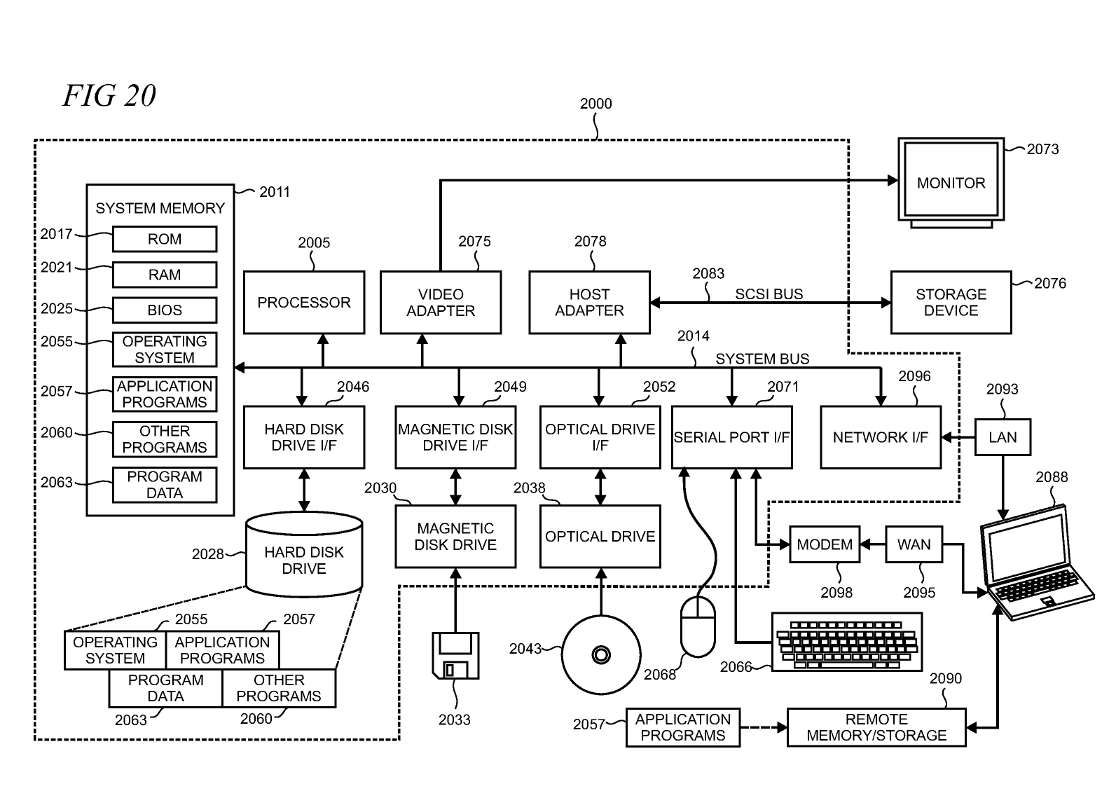

FIG. 20 is a simplified block diagram of an illustrative computer system 2000 such as a PC, client machine, or server with which the present actionable souvenir from real-time sharing may be implemented. Computer system 2000 includes a processor 2005, a system memory 2011, and a system bus 2014 that couples various system components including the system memory 2011 to the processor 2005. The system bus 2014 may be any of several types of bus structures including a memory bus or memory controller, a peripheral bus, or a local bus using any of a variety of bus architectures. The system memory 2011 includes read only memory (ROM) 2017 and random access memory (RAM) 2021. A basic input/output system (BIOS) 2025, containing the basic routines that help to transfer information between elements within the computer system 2000, such as during startup, is stored in ROM 2017. The computer system 2000 may further include a hard disk drive 2028 for reading from and writing to an internally disposed hard disk (not shown), a magnetic disk drive 2030 for reading from or writing to a removable magnetic disk 2033 (e.g., a floppy disk), and an optical disk drive 2038 for reading from or writing to a removable optical disk 2043 such as a CD (compact disc), DVD (digital versatile disc), or other optical media. The hard disk drive 2028, magnetic disk drive 2030, and optical disk drive 2038 are connected to the system bus 2014 by a hard disk drive interface 2046, a magnetic disk drive interface 2049, and an optical drive interface 2052, respectively. The drives and their associated computer-readable storage media provide non-volatile storage of computer-readable instructions, data structures, program modules, and other data for the computer system 2000. Although this illustrative example includes a hard disk, a removable magnetic disk 2033, and a removable optical disk 2043, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present actionable souvenir from real-time sharing. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2033, optical disk 2043, ROM 2017, or RAM 2021, including an operating system 2055, one or more application programs 2057, other program modules 2060, and program data 2063. A user may enter commands and information into the computer system 2000 through input devices such as a keyboard 2066 and pointing device 2068 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 2005 through a serial port interface 2071 that is coupled to the system bus 2014, but may be connected by other interfaces, such as a parallel port, game port, or universal serial bus (USB). A monitor 2073 or other type of display device is also connected to the system bus 2014 via an interface, such as a video adapter 2075. In addition to the monitor 2073, personal computers typically include other peripheral output devices (not shown), such as speakers and printers. The illustrative example shown in FIG. 20 also includes a host adapter 2078, a Small Computer System Interface (SCSI) bus 2083, and an external storage device 2076 connected to the SCSI bus 2083.

The computer system 2000 is operable in a networked environment using logical connections to one or more remote computers, such as a remote computer 2088. The remote computer 2088 may be selected as another personal computer, a server, a router, a network PC, a peer device, or other common network node, and typically includes many or all of the elements described above relative to the computer system 2000, although only a single representative remote memory/storage device 2090 is shown in FIG. 20. The logical connections depicted in FIG. 20 include a local area network (LAN) 2093 and a wide area network (WAN) 2095. Such networking environments are often deployed, for example, in offices, enterprise-wide computer networks, intranets, and the Internet.

When used in a LAN networking environment, the computer system 2000 is connected to the local area network 2093 through a network interface or adapter 2096. When used in a WAN networking environment, the computer system 2000 typically includes a broadband modem 2098, network gateway, or other means for establishing communications over the wide area network 2095, such as the Internet. The broadband modem 2098, which may be internal or external, is connected to the system bus 2014 via a serial port interface 2071. In a networked environment, program modules related to the computer system 2000, or portions thereof, may be stored in the remote memory storage device 2090. It is noted that the network connections shown in FIG. 20 are illustrative and other means of establishing a communications link between the computers may be used depending on the specific requirements of an application of the present actionable souvenir from real-time sharing.

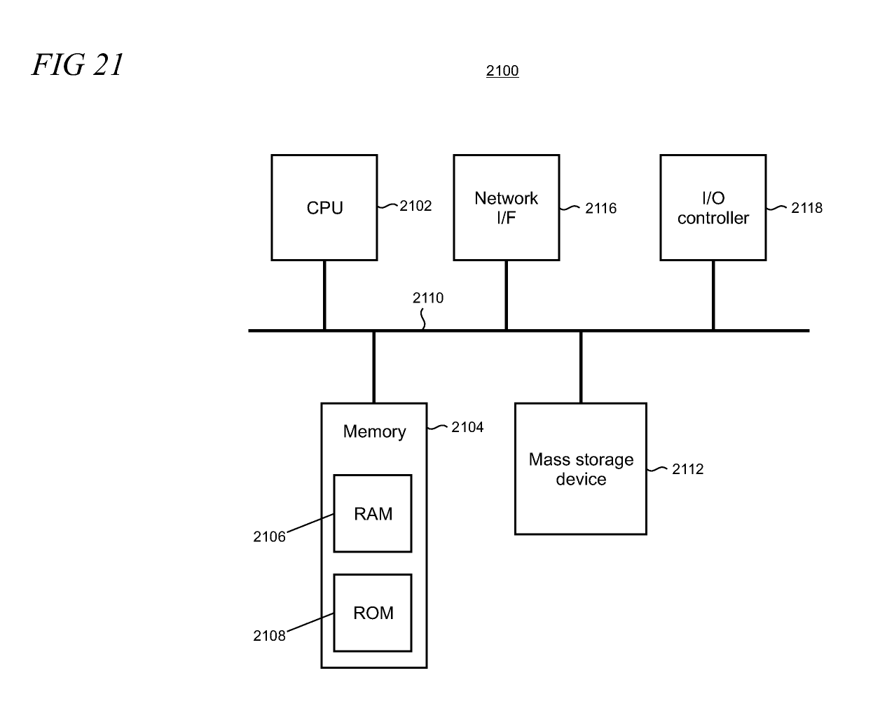

FIG. 21 shows an illustrative architecture 2100 for a device capable of executing the various components described herein for providing the present actionable souvenir from real-timing sharing. Thus, the architecture 2100 illustrated in FIG. 21 shows an architecture that may be adapted for a server computer, mobile phone, a PDA, a smartphone, a desktop computer, a netbook computer, a tablet computer, GPS device, gaming console, and/or a laptop computer. The architecture 2100 may be utilized to execute any aspect of the components presented herein.

The architecture 2100 illustrated in FIG. 21 includes a CPU (Central Processing Unit) 2102, a system memory 2104, including a RAM 2106 and a ROM 2108, and a system bus 2110 that couples the memory 2104 to the CPU 2102. A basic input/output system containing the basic routines that help to transfer information between elements within the architecture 2100, such as during startup, is stored in the ROM 2108. The architecture 2100 further includes a mass storage device 2112 for storing software code or other computer-executed code that is utilized to implement applications, the file system, and the operating system.

The mass storage device 2112 is connected to the CPU 2102 through a mass storage controller (not shown) connected to the bus 2110. The mass storage device 2112 and its associated computer-readable storage media provide non-volatile storage for the architecture 2100.

Although the description of computer-readable storage media contained herein refers to a mass storage device, such as a hard disk or CD-ROM drive, it may be appreciated by those skilled in the art that computer-readable storage media can be any available storage media that can be accessed by the architecture 2100.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 3700.

According to various embodiments, the architecture 2100 may operate in a networked environment using logical connections to remote computers through a network. The architecture 2100 may connect to the network through a network interface unit 2116 connected to the bus 2110. It may be appreciated that the network interface unit 2116 also may be utilized to connect to other types of networks and remote computer systems. The architecture 2100 also may include an input/output controller 2118 for receiving and processing input from a number of other devices, including a keyboard, mouse, or electronic stylus (not shown in FIG. 21). Similarly, the input/output controller 2118 may provide output to a display screen, a printer, or other type of output device (also not shown in FIG. 21).

It may be appreciated that the software components described herein may, when loaded into the CPU 2102 and executed, transform the CPU 2102 and the overall architecture 2100 from a general-purpose computing system into a special-purpose computing system customized to facilitate the functionality presented herein. The CPU 2102 may be constructed from any number of transistors or other discrete circuit elements, which may individually or collectively assume any number of states. More specifically, the CPU 2102 may operate as a finite-state machine, in response to executable instructions contained within the software modules disclosed herein. These computer-executable instructions may transform the CPU 2102 by specifying how the CPU 2102 transitions between states, thereby transforming the transistors or other discrete hardware elements constituting the CPU 2102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 2100 in order to store and execute the software components presented herein. It may also be appreciated that the architecture 2100 may include other types of computing devices, including handheld computers, embedded computer systems, smartphones, PDAs, and other types of computing devices known to those skilled in the art. It is also contemplated that the architecture 2100 may not include all of the components shown in FIG. 21, may include other components that are not explicitly shown in FIG. 21, or may utilize an architecture completely different from that shown in FIG. 21.

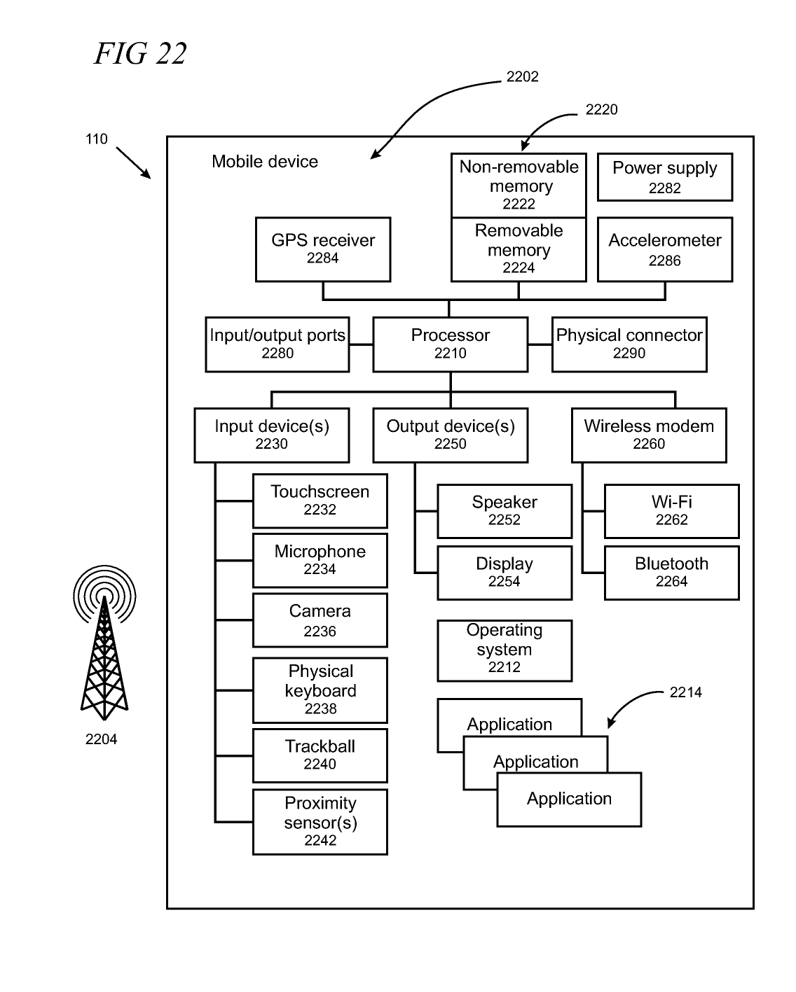

FIG. 22 is a functional block diagram of an illustrative mobile device 110 such as a mobile phone or smartphone including a variety of optional hardware and software components, shown generally at 2202. Any component 2202 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 2204, such as a cellular or satellite network.

The illustrated device 110 can include a controller or processor 2210 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 2212 can control the allocation and usage of the components 2202, including power states, above-lock states, and below-lock states, and provides support for one or more application programs 2214. The application programs can include common mobile computing applications (e.g., image-capture applications, email applications, calendars, contact managers, web browsers, messaging applications), or any other computing application.

The illustrated mobile device 110 can include memory 2220. Memory 2220 can include non-removable memory 2222 and/or removable memory 2224. The non-removable memory 2222 can include RAM, ROM, Flash memory, a hard disk, or other well-known memory storage technologies. The removable memory 2224 can include Flash memory or a Subscriber Identity Module (SIM) card, which is well known in GSM (Global System for Mobile communications) systems, or other well-known memory storage technologies, such as “smart cards.” The memory 2220 can be used for storing data and/or code for running the operating system 2212 and the application programs 2214. Example data can include web pages, text, images, sound files, video data, or other data sets to be sent to and/or received from one or more network servers or other devices via one or more wired or wireless networks.

The memory 2220 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the mobile device 110.

The memory 2220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The mobile device 110 can support one or more input devices 2230; such as a touch screen 2232; microphone 2234 for implementation of voice input for voice recognition, voice commands and the like; camera 2236; physical keyboard 2238; trackball 2240; and/or proximity sensor 2242; and one or more output devices 2250, such as a speaker 2252 and one or more displays 2254. Other input devices (not shown) using gesture recognition may also be utilized in some cases. Other possible output devices (not shown) can include piezoelectric or haptic output devices. Some devices can serve more than one input/output function. For example, touchscreen 2232 and display 2254 can be combined into a single input/output device.

A wireless modem 2260 can be coupled to an antenna (not shown) and can support two-way communications between the processor 2210 and external devices, as is well understood in the art. The modem 2260 is shown generically and can include a cellular modem for communicating with the mobile communication network 2204 and/or other radio-based modems (e.g., Bluetooth 2264 or Wi-Fi 2262). The wireless modem 2260 is typically configured for communication with one or more cellular networks, such as a GSM network for data and voice communications within a single cellular network, between cellular networks, or between the mobile device and a public switched telephone network (PSTN).

The mobile device can further include at least one input/output port 2280, a power supply 2282, a satellite navigation system receiver 2284, such as a GPS receiver, an accelerometer 2286, a gyroscope (not shown), and/or a physical connector 2290, which can be a USB port, IEEE 1394 (FireWire) port, and/or an RS-232 port. The illustrated components 2202 are not required or all-inclusive, as any components can be deleted and other components can be added.

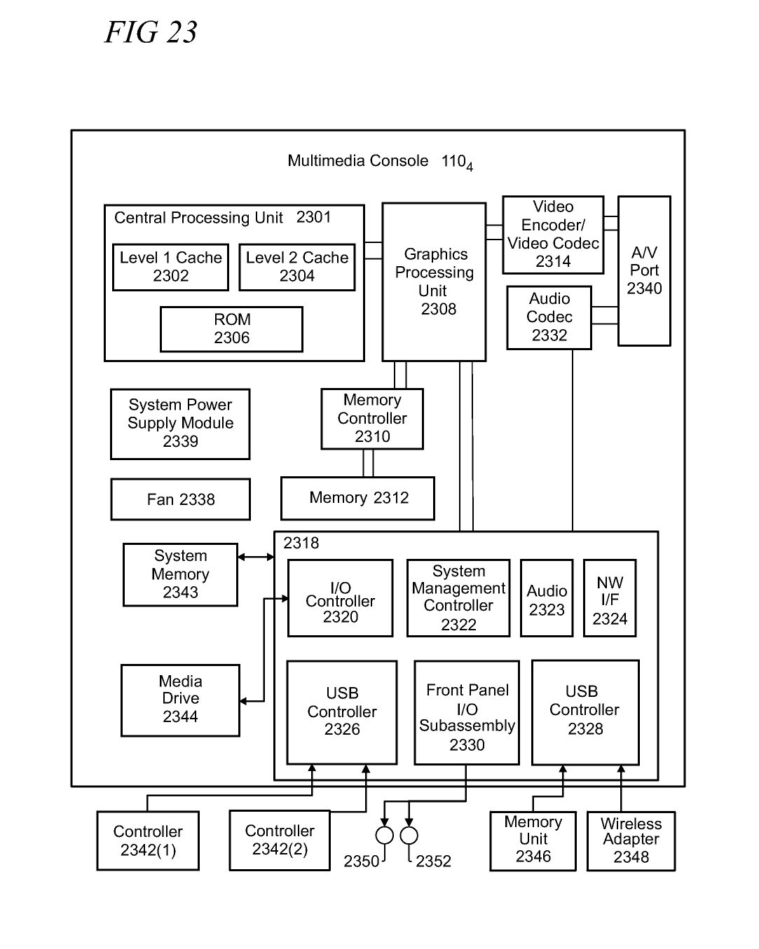

FIG. 23 is an illustrative functional block diagram of a multimedia console 110₄. The multimedia console 110₄ has a central processing unit (CPU) 2301 having a level 1 cache 2302, a level 2 cache 2304, and a Flash ROM (Read Only Memory) 2306. The level 1 cache 2302 and the level 2 cache 2304 temporarily store data and hence reduce the number of memory access cycles, thereby improving processing speed and throughput. The CPU 2301 may be configured with more than one core, and thus, additional level 1 and level 2 caches 2302 and 2304. The Flash ROM 2306 may store executable code that is loaded during an initial phase of a boot process when the multimedia console 110₄ is powered ON.

A graphics processing unit (GPU) 2308 and a video encoder/video codec (coder/decoder) 2314 form a video processing pipeline for high speed and high resolution graphics processing. Data is carried from the GPU 2308 to the video encoder/video codec 2314 via a bus. The video processing pipeline outputs data to an A/V (audio/video) port 2340 for transmission to a television or other display. A memory controller 2310 is connected to the GPU 2308 to facilitate processor access to various types of memory 2312, such as, but not limited to, a RAM.

The multimedia console 110₄ includes an I/O controller 2320, a system management controller 2322, an audio processing unit 2323, a network interface controller 2324, a first USB (Universal Serial Bus) host controller 2326, a second USB controller 2328, and a front panel I/O subassembly 2330 that are preferably implemented on a module 2318. The USB controllers 2326 and 2328 serve as hosts for peripheral controllers 2342(1) and 2342(2), a wireless adapter 2348, and an external memory device 2346 (e.g., Flash memory, external CD/DVD ROM drive, removable media, etc.). The network interface controller 2324 and/or wireless adapter 2348 provide access to a network (e.g., the Internet, home network, etc.) and may be any of a wide variety of various wired or wireless adapter components including an Ethernet card, a modem, a Bluetooth module, a cable modem, or the like.

System memory 2343 is provided to store application data that is loaded during the boot process. A media drive 2344 is provided and may comprise a DVD/CD drive, hard drive, or other removable media drive, etc. The media drive 2344 may be internal or external to the multimedia console 110₄. Application data may be accessed via the media drive 2344 for execution, playback, etc. by the multimedia console 110₄. The media drive 2344 is connected to the I/O controller 2320 via a bus, such as a Serial ATA bus or other high speed connection (e.g., IEEE 1394).

The system management controller 2322 provides a variety of service functions related to assuring availability of the multimedia console 110₄. The audio processing unit 2323 and an audio codec 2332 form a corresponding audio processing pipeline with high fidelity and stereo processing. Audio data is carried between the audio processing unit 2323 and the audio codec 2332 via a communication link. The audio processing pipeline outputs data to the A/V port 2340 for reproduction by an external audio player or device having audio capabilities.

The front panel I/O subassembly 2330 supports the functionality of the power button 2350 and the eject button 2352, as well as any LEDs (light emitting diodes) or other indicators exposed on the outer surface of the multimedia console 110₄. A system power supply module 2336 provides power to the components of the multimedia console 110₄. A fan 2338 cools the circuitry within the multimedia console 110₄.

The CPU 2301, GPU 2308, memory controller 2310, and various other components within the multimedia console 110₄ are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 110₄ is powered ON, application data may be loaded from the system memory 2343 into memory 2312 and/or caches 2302 and 2304 and executed on the CPU 2301. The application may present a graphical user interface that provides a consistent user experience when navigating to different media types available on the multimedia console 110₄. In operation, applications and/or other media contained within the media drive 2344 may be launched or played from the media drive 2344 to provide additional functionalities to the multimedia console 110₄.

The multimedia console 110₄ may be operated as a standalone system by simply connecting the system to a television or other display. In this standalone mode, the multimedia console 110₄ allows one or more users to interact with the system, watch movies, or listen to music. However, with the integration of broadband connectivity made available through the network interface controller 2324 or the wireless adapter 2348, the multimedia console 110₄ may further be operated as a participant in a larger network community.

When the multimedia console 110₄ is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 110₄ boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 2301 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 2342(1) and 2342(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Various exemplary embodiments of the present actionable souvenir from real-time sharing are now presented by way of illustration and not as an exhaustive list of all embodiments. An example includes one or more computer-readable memories storing instructions which, when executed by one or more processors disposed in a device, implement a method for retaining access to content or experiences from a real-time sharing session between two or more participants, comprising: generating a sharing history for the real-time sharing session, the generating including monitoring shared content and sharing events that are associated with the real-time sharing session; utilizing the sharing history to create a souvenir for the real-time sharing session, the souvenir being actionable for providing post-sharing access to content and experiences which maintain the functionalities exposed in the real-time sharing session, the functionalities including at least one of user-generated content, links, or contextually dynamic content; distributing the souvenir to one or more of the real-time sharing participants over a communications network; and writing data associated with the actionable souvenir to one or more data stores.

In another example, the one or more computer-readable memories further include causing the souvenir to be surfaced on the device according to user preferences. In another example, the one or more computer-readable memories further include collecting contextual data describing at least one of stored contacts, device user behavior, links to the device user's social graph, call history, messaging history, browser history, device characteristics, communications network type, mobile data plans, mobile data plan restrictions, enterprise policies, job-related policies, user preferences, time/date, language, application behaviors and associated data including at least one of game score or percent completion of an application process, environmental conditions or physiological conditions captured by one or more sensors, or appointments. In another example, the one or more computer-readable memories further include using the contextual data to surface, at a contextually relevant time, the souvenir or a souvenir reminder, or surfacing the souvenir or souvenir reminder upon an occurrence of a qualifying event, or terminating a souvenir upon an occurrence of a qualifying event. In another example, the one or more computer-readable memories further include determining a data store location according one of rules or heuristics that apply contextual data, the location being local to the device or remote from the device. In another example, the user-generated content comprises one or more of mark-ups, annotations, commentary, audio/video, content links, highlights, animations, graphics, drawings, directions, or points-of-interest. In another example, the shared content includes a shared screen or the shared content includes content that is merged from two or more real-time sharing sessions. In another example, the one or more computer-readable memories further include enabling control over access of a real-time sharing participant's access to shared content after the real-time sharing is completed, the controlling including one of enabling or disabling shared content to be saved, enabling shared content to be accessed for a predetermined time interval after the completion, enabling shared content to be streamed without being saved, disabling access upon an occurrence of an event, the event including one of progress in an application process meeting a threshold percentage of completion, achieving a high score in a game, or new content becoming available, or enabling a souvenir to expire. In another example, the souvenir includes a deep link to web-based content. In another example, the one or more computer-readable memories further include deactivating a souvenir when a contact goes stale.

A further example includes a device, comprising: one or more processors; a display that supports a user interface (UI) for interacting with a device user; and a memory storing computer-readable instructions which, when executed by the one or more processors, perform a method for sharing content between devices comprising the steps of: enabling content to be selected for sharing during a real-time sharing session, providing tools for creating user-generated content (UGC) to accompany the shared content in the real-time sharing session, receiving an actionable souvenir for the real-time sharing session after the real-time sharing session is completed, and when the actionable souvenir is invoked, rendering a post-sharing local re-creation of the shared content including the UGC on the device.

In another example, the device further includes configuring the tools for editing, modifying, or supplementing the selected shared content. In another example, the tools are exposed as a functionality of a unified communications system supporting at least of voice calling, voice conferencing, video calling, video conferencing, or messaging. In another example, the unified communication system employs service and client-side components. In another example, the unified communications system is configured to expose an application programming interface for interacting with an actionable souvenir. In another example, the device further includes configuring the tools for placing restrictions on actionable souvenirs transmitted to devices used by other participants to the real-time sharing so that a subset of content shared during the real-time sharing is available for use with post-sharing re-creations.

A further example includes a method for retaining access to content shared during a real-time session between a local device used by a local participant and a remote device used by a remote participant, the method comprising the steps of: monitoring occurrences of events, and content or experiences shared from the local device, during a real-time sharing session; generating an actionable souvenir for accessing the shared content or experiences after the real-time sharing is completed; sending a message to the remote device over a network, the message including a link to the actionable souvenir; and when the remote party follows the link, implementing a web service with a web service client on the remote device, the web service enabling access at the remote device to the content or shared experiences after the real-time sharing is completed.

In another example, the web service client comprises a web browser. In another example, the local device and remote device implement sharing of content or experiences using a cross-platform configuration. In another example, the message is sent over a messaging service operating on a communications network.

Based on the foregoing, it may be appreciated that technologies for actionable souvenirs from real-time sharing have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and may not be construed as limiting. Various modifications and changes may be made to the subject matter described herein without following the example embodiments and applications illustrated and described, and without departing from the true spirit and scope of the present invention, which is set forth in the following claims.

What is claimed:

1. One or more computer-readable memories storing instructions which, when executed by one or more processors disposed in a device, implement a method for retaining access to content or experiences from a real-time sharing session between two or more participants, comprising:
generating a sharing history for the real-time sharing session, the generating including monitoring shared content and sharing events that are associated with the real-time sharing session;
utilizing the sharing history to create a souvenir for the real-time sharing session, the souvenir being actionable for providing post-sharing access to content and experiences which maintain the functionalities exposed in the real-time sharing session, the functionalities including at least one of user-generated content, links, or contextually dynamic content;
distributing the souvenir to one or more of the real-time sharing participants over a communications network; and
writing data associated with the actionable souvenir to one or more data stores.

2. The one or more computer-readable memories of claim 1 further including causing the souvenir to be surfaced on the device according to user preferences.

3. The one or more computer-readable memories of claim 1 further including collecting contextual data describing at least one of stored contacts, device user behavior, links to the device user's social graph, call history, messaging history, browser history, device characteristics, communications network type, mobile data plans, mobile data plan restrictions, enterprise policies, job-related policies, user preferences, time/date, language, application behaviors and associated data including at least one of game score or percent completion of an application process, environmental conditions or physiological conditions captured by one or more sensors, or appointments.

4. The one or more computer-readable memories of claim 3 further including using the contextual data to surface, at a contextually relevant time, the souvenir or a souvenir reminder, or surfacing the souvenir or souvenir reminder upon an occurrence of a qualifying event, or terminating a souvenir upon an occurrence of a qualifying event.

5. The one or more computer-readable memories of claim 1 further including determining a data store location according one of rules or heuristics that apply contextual data, the location being local to the device or remote from the device.

6. The one or more computer-readable memories of claim 1 in which the user-generated content comprises one or more of mark-ups, annotations, commentary, audio/video, content links, highlights, animations, graphics, drawings, directions, or points-of-interest.

7. The one or more computer-readable memories of claim 1 in which the shared content includes a shared screen or the shared content includes content that is merged from two or more real-time sharing sessions.

8. The one or more computer-readable memories of claim 1 further including enabling control over access of a real-time sharing participant's access to shared content after the real-time sharing is completed, the controlling including one of enabling or disabling shared content to be saved, enabling shared content to be accessed for a predetermined time interval after the completion, enabling shared content to be streamed without being saved, disabling access upon an occurrence of an event, the event including one of progress in an application process meeting a threshold percentage of completion, achieving a high score in a game, or new content becoming available, or enabling a souvenir to expire.

9. The one or more computer-readable memories of claim 1 in which the souvenir includes a deep link to web-based content.

10. The one or more computer-readable memories of claim 1 further including deactivating a souvenir when a contact goes stale.

11. A device, comprising:
one or more processors;
a display that supports a user interface (UI) for interacting with a device user; and
a memory storing computer-readable instructions which, when executed by the one or more processors, perform a method for sharing content between devices comprising the steps of:
enabling content to be selected for sharing during a real-time sharing session,
providing tools for creating user-generated content (UGC) to accompany the shared content in the real-time sharing session,
receiving an actionable souvenir for the real-time sharing session after the real-time sharing session is completed, and
when the actionable souvenir is invoked, rendering a post-sharing local re-creation of the shared content including the UGC on the device.

12. The device of claim 11 further including configuring the tools for editing, modifying, or supplementing the selected shared content.

13. The device of claim 12 in which the tools are exposed as a functionality of a unified communications system supporting at least of voice calling, voice conferencing, video calling, video conferencing, or messaging.

14. The device of claim 13 in which the unified communication system employs service and client-side components.

15. The device of claim 14 in which the unified communications system is configured to expose an application programming interface for interacting with an actionable souvenir.

16. The device of claim 11 further including configuring the tools for placing restrictions on actionable souvenirs transmitted to devices used by other participants to the real-time sharing so that a subset of content shared during the real-time sharing is available for use with post-sharing re-creations.

17. A method for retaining access to content shared during a real-time session between a local device used by a local participant and a remote device used by a remote participant, the method comprising the steps of:
monitoring occurrences of events, and content or experiences shared from the local device, during a real-time sharing session;
generating an actionable souvenir for accessing the shared content or experiences after the real-time sharing is completed;
sending a message to the remote device over a network, the message including a link to the actionable souvenir; and
when the remote party follows the link, implementing a web service with a web service client on the remote device, the web service enabling access at the remote device to the content or shared experiences after the real-time sharing is completed.

18. The method of claim 17 in which the web service client comprises a web browser.

19. The method of claim 17 in which the local device and remote device implement sharing of content or experiences using a cross-platform configuration.

20. The method of claim 17 in which the message is sent over a messaging service operating on a communications network.
